(19) United States
(12) Patent Application Publication
(10) Pub. No.: US 2006/0291787 A1
(43) Pub. Date: Dec. 28, 2006

(54) Fiber optic cable having strength component

(76) Inventor: David A. Seddon, Hickory, NC (US)

Correspondence Address: CORNING CABLE SYSTEMS LLC, P O BOX 489, HICKORY, NC, 28603, US

(21) Appl. No.: 11/167,669

(22) Filed: Jun. 27, 2005

(51) Int. Cl. G02B 6/44

(52) U.S. Cl. 385/113; 385/100; 385/102; 385/103; 385/109

(57) ABSTRACT

A fiber optic cable including at least one optical transmission component, a strength component axially aligned with the fiber optic cable and having a predetermined elongate shape and a cable sheath surrounding the at least one optical transmission component and the strength component and having a predetermined geometric configuration. A strength component positioned generally adjacent the at least one optical transmission component such that the strength component and the at least one optical transmission component are positioned along a common axis in order to provide the fiber optic cable with a preferential bend. A strength component having a predetermined elongate shape to protect against crush, impact and rotational forces applied to the cable.

### BACKGROUND OF THE INVENTION

1. Field of the Invention

The present invention relates generally to fiber optic cables, and more specifically, to fiber optic cables that include at least one optical transmission component and a shaped strength component for providing a preferential bend in the cables.

2. Technical Background

Optical fiber is increasingly being used for a variety of broadband applications including voice, video and data transmissions. As a result, optical networks are being built that include fiber optic cables containing at least one optical fiber for transmitting data, computer and telecommunications information. Conventional drop cable designs typically include two or more rod-shaped strength members of circular cross section positioned on opposing sides of at least one optical transmission component, such as a buffer tube. The two or more strength members work together to provide rotational stability to the cable and resist bending along an undesired bend axis. These conventional cable designs can require undesirable and complicated features that make the cables difficult to manufacture. In addition, accessing optical fibers can be difficult and/or the cable can be expensive to produce.

One example of a commercialized cable design is an SST-Drop™ Dielectric Cable available from Corning Cable Systems of Hickory, N.C. These particular cables are outside plant cables containing a buffer tube with up to 12 fibers. The cable has a flat shape, with dielectric strength members situated on both sides of the buffer tube. This feature makes the cable especially versatile with exceptional crush and impact resistance. Another exemplary cable is an SST-Drop™ Armored Cable also available from Corning Cable Systems of Hickory, N.C. The cable is an outside plant cable containing a buffer tube with up to 12 optical fibers. The cable has a round shape, with steel tape armor adjacent to the outside of the buffer tube and with dielectric strength members situated on opposing sides of the steel tape armor.

While the conventional cable designs described above are able to withstand crush, impact, tension and rotational forces placed upon the cables, and while the two or more strength members are generally located in a plane to promote a preferential bending axis, these conventional cable designs are not the only way to achieve the desired performance characteristics. Accordingly, there is a specific and unresolved need for a more simple cable design including fewer components while still providing the cable with a preferential bend such that the cable is not subjected to undesirable axial tension or rotational loads induced by bending during normal handling and deployment. It is further desirable to provide a fiber optic cable having a strength component with a predetermined shape, wherein the predetermined shape performs the function of two or more spaced-apart strength members of conventional cable designs. The shaped strength component reduces the complexity of the cable design, provides improved access to the optical transmission components and is potentially less expensive and easier to manufacture. The fiber optic cable should have a cross-section no larger than current cable designs and should be sufficiently flexible to satisfy demanding installation requirements, such as through small-diameter conduits and over sheave wheels and pulleys.

### SUMMARY OF THE INVENTION

In one aspect, the present invention provides a fiber optic cable including at least one optical transmission component and a preferential bend strength component having a predetermined shape and position within the cable relative to the at least one optical transmission component. The strength component provides protection against bending, crush, and impact forces placed on the cable and further provides a preferential bend axis for the cable, thereby preventing breakage of the at least one optical fiber due to axial tension stresses induced by bending and improving optical performance by avoiding stress induced optical attenuation. In particular, the strength component protects the at least one optical fiber during normal handling, cable reeling, un-reeling and installation within a conduit system or through aerial installation equipment, such as sheave wheels or pulleys.

In another aspect, the present invention provides a flexible fiber optic cable having a preferential bend and good torsional stiffness when the cable is in a loop. The fiber optic cable includes at least one optical component, for example, at least one optical fiber disposed within a buffer tube, and at least one preferential bend strength component having a predetermined shape. Preferably, the at least one optical component is aligned with the strength component along a common neutral bending axis such that the cable bends about the neutral axis and bend stresses induced in the optical component are minimized. The strength component of the present invention has characteristics including stiffness, a cross sectional shape that distributes bending stresses across a non-circular cross section, for example, a generally flat or oval cross section, that provides the preferential bend in the cable during cable bending. The cable has a jacket surrounding the at least one optical transmission component and the strength component. Water-swellable components and/or yarns may be added to the fiber optic cable in deployments where water tightness is an issue.

In yet another aspect, the present invention provides a flexible fiber optic cable having a preferential bend and including at least one optical transmission component, at least one preferential bend strength component having a predetermined shape and a cable sheath having a predetermined geometrical configuration such that the fiber optic cable bends along a preferred axis. Preferably, the strength component defines an elongate cross sectional shape and, in various embodiments, defines at least one thickened portion to increase protection against crush and impact forces. The geometrical configuration of the cable sheath is preferably elongate and may include a thickened portion or concave surfaces in alternative embodiments. The strength component protects against crush, impact and torsional forces applied to the fiber optic cable and is axially aligned with the fiber optic cable. The strength component is preferably made of a dielectric material formed into a generally elongated shape having a width greater than its height.

Additional features and advantages of the invention are set out in the detailed description which follows, and in part will be readily apparent to those skilled in the art from that description or recognized by practicing the invention as described herein, including the detailed description which follows, the claims, as well as the appended drawings.

The foregoing general description and the following detailed description present exemplary embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention, and together with the detailed description, serve to explain the principles and operations thereof. Additionally, the drawings and descriptions are meant to be illustrative and not limiting.

### BRIEF DESCRIPTION OF THE DRAWINGS

FIG. 1 is a perspective view of a fiber optic cable including an optical transmission component and a preferential bend strength component in accordance with an exemplary embodiment of the present invention;

FIG. 2 is a cross-sectional view of the fiber optic cable of FIG. 1 taken along line 2-2, and FIG. 2A shows a cable similar to that of FIG. 2 but having at least two preferential bend strength components;

FIG. 3 is a perspective view of a fiber optic cable including an optical transmission component and a preferential bend strength component in accordance with another exemplary embodiment of the present invention;

FIG. 4 is a cross-sectional view of the fiber optic cable of FIG. 3 taken along line 4-4, and FIG. 4A shows a cable similar to that of FIG. 4 but having at least two preferential bend strength components;

FIG. 5 is a perspective view of a fiber optic cable including an optical transmission component and a, shaped strength component in accordance with yet another exemplary embodiment of the present invention; and

FIG. 6 is a cross-sectional view of the fiber optic cable of FIG. 5 taken along line 6-6.

### DETAILED DESCRIPTION OF THE PREFERRED EMBODIMENTS

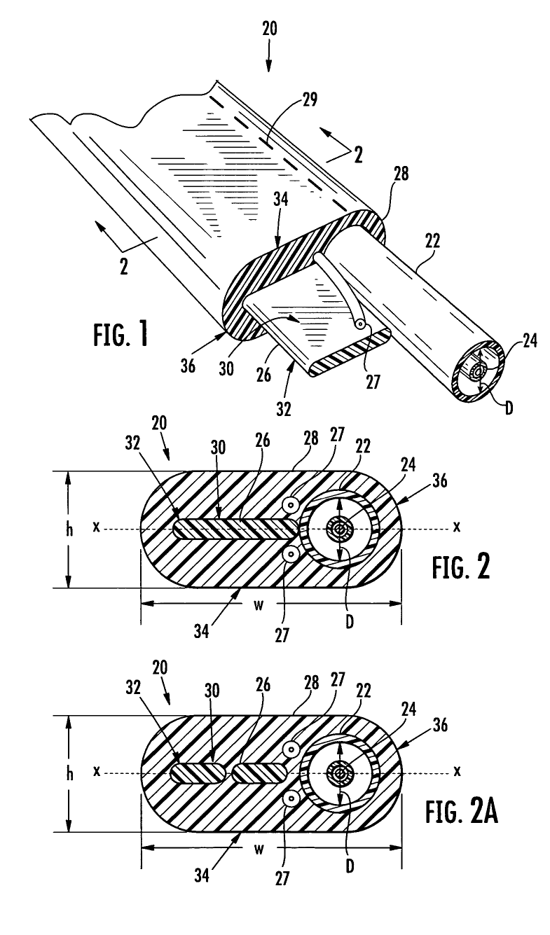

Reference will now be made in detail to the present preferred embodiments of the invention, and examples of which are illustrated in the accompanying drawings. Whenever possible, the same reference numerals will be used throughout the drawings to refer to the same or like parts. A fiber optic cable including at least one optical transmission component and a preferential bend strength component having at least one predetermined shape is shown in FIGS. 1-6 and is designated generally throughout by reference number 20. In all embodiments shown, the fiber optic cable 20 is flexible, easy to route and has a preferential bend characteristic. Preferably, the fiber optic cable is an outside plant drop cable designed for aerial self-support, overlash, placement within a conduit or direct-buried applications.

Referring specifically to FIGS. 1 and 2, an exemplary embodiment of a fiber optic cable including a preferential bend strength component having a predetermined shape is shown and described. FIG. 1 is a perspective view of the fiber optic cable 20 shown with the cable sheath cut back, while FIG. 2 is a cross-sectional view of the fiber optic cable of FIG. 1 taken along line 2-2. The fiber optic cable 20 includes at least one optical transmission component, for example, a tubular body such as a buffer tube 22 having at least one optical fiber 24 loosely received therein. The buffer tube 22 preferably defines a nominal diameter D of about 3 mm or less, and is preferably formed of polypropylene or polybutylene terephthalate and blends thereof, but it can be formed of, for example, polyethylene and blends thereof. Preferably, the buffer tube 22 is filled with a water absorptive or water blocking gel, for example, a non-hygroscopic, non-nutritive to fungus, electrically non-conductive, homogenous gel that is readily removable using conventional solvents. Preferably, various types of optical fibers may be accommodated such as, but not limited to, single mode and multi-mode optical fibers including one or more bare optical fibers, coated optical fibers, loose-tube optical fibers, tight-buffered optical fibers, ribbonized optical fibers or any other expedient for transmitting light signals now known or hereafter developed. The fiber optic cable 20 is preferably designed to provide stable performance over a wide range of temperatures and to be compatible with any telecommunications grade optical fiber in any number or configuration.

In preferred embodiments, the optical transmission component is aligned with and disposed adjacent to at least one preferential bend strength component 26 having a predetermined shape, for example, an elongate cross sectional shape. The strength component 26 is operable for providing tensile strength and a preferential bend along a general bending axis X-X that passes through the strength component 26 and the optical transmission component. In other words, the optical component is generally aligned with the neutral bending axis which minimizes stresses in the optical component and preserves optical performance by avoiding or minimizing stress-induced optical attenuation. If a force is applied to the cable 20, the axial alignment, tensile strength and predetermined shape of the strength component 26 minimize torsion and cause the cable 20 to bend along the common axis X-X. Furthermore, the positioning and the shape of the strength component 26 creates a preferential bend in the cable 20 along the common axis X-X such that the magnitude of the axial stresses in the at least one optical fibers 24 routed substantially along the common axis X-X is minimized, thereby preventing failure or breakage of the at least one optical fibers 24 and minimizing optical attenuation changes. Finally, the use of the strength component 26 preserves the integrity of the cable sheath 28 by creating a preferential bend along an axis that reduces the amount of stress in the thinnest or weakest areas of the cable sheath 28. In the alternative embodiments of FIGS. 2A and 4A, fiber optic cables according to the present invention having a preferential bend characteristic can include two or more preferential bend strength components aligned with each other and the optical component.

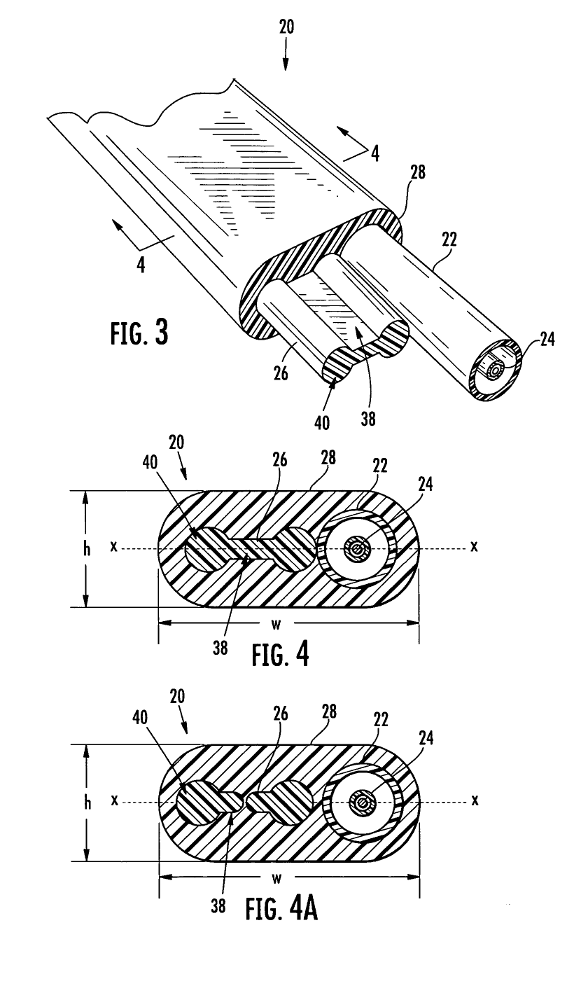

The strength component 26 shown is axially elongate, and has an elongate cross section and stiffness which impart a preferential bend axis to it, for example, the preferential bend component can include generally flat sides 30 and arcuate ends 32, similar to the shape of the cable sheath 28 and in contrast to conventional strength components having a circular cross-section rod-like shape. However, it will be appreciated by those skilled in the art that the strength component 26 may have a variety of different shapes sufficient to impart a preferential bend characteristic in the fiber optic cable, as is shown in the embodiments of FIGS. 3-6. One or more strength yarns or fibers, for example, fiberglass or aramid fibers, can be included in any embodiment of the present invention, as shown for example in the embodiment of FIGS. 1-2, for enhancing the tensile strength rating of the cable. The exemplary generally flat or oval strength component 26 provides good torsional stiffness when the cable 20 is in a loop and has sufficient strength to be equivalent to the SST-Drop™ Dielectric Cable available from Corning Cable Systems of Hickory, N.C. In order to keep the stiffness of the strength component 26 in the preferred plane, the width of the strength component 26 is greater than the height of the strength component 26.

The strength component 26 is positioned within the fiber optic cable 20 at substantially the center of the height h of the cable 20, while the optical transmission component and the strength component together are positioned at substantially the center of the width w of the cable 20. Preferably, the strength component 26 is a solid member formed of dielectric materials, for example, glass reinforced plastic (GRP). A preferred bending modulus for preferential bend strength components suitable for use in the present invention is within a range of about 10 kNmm² to about 50 kNmm². However, it will be understood by those skilled in the art that any plastic, fiber-glass, composite, yarn or metal material having a bend radius compatible with the bend radius of the fiber optic cable 20 may be used. Preferably, the strength component 26 has a tensile strength rating of about 500 Newton's @ 0.5% strain. The tensile stiffness or EA of the cable is preferably in the range 100 kN to 300 kN which is equivalent to a tensile strength at 0.5% strain of 500 to 1,500N. The 500N level is preferable along with positive excess fiber length in the tube or the spans are short (for aerial cables). The strength component 26 has both tensile and anti-buckling characteristics. In alternative embodiments, the strength component 26 may include a coating adhered to its outer surface comprising a water-swellable powder in a plastic matrix.

The buffer tube 22 and the strength component 26 are preferably surrounded by a cable sheath 28 formed of a thermoplastic, e.g., PVC or MDPE, such as MPDE as defined by ASTM D1248, Type II, Class C, Category 4, Grade J4. The minimum average sheath thickness is about 0.75 mm and the MPDE preferably contains carbon black to provide ultraviolet light protection. The cable sheath material forms a molded body that provides an outer protective shell, maintains sealing integrity between the underlying components and the external environment and is capable of withstanding crush forces, and to withstand up to at least about 300 lbs of tensile load The actual degree of flexibility, and in particular the bending and torsion flexibility, is dependent upon the sheath material chosen and the geometry of the underlying components. Any cable sheath used in the embodiments of the present invention can include one or more indicia there for locating the optical component, for example, an indicia 29 as shown on sheath 28 (FIG. 1).

In the embodiments shown in FIGS. 1-4, the fiber optic cable 20 has a generally flat geometry. The cable sheath 28 defines generally flat sides 34 and generally arcuate ends 36. In the preferred embodiment, the width w of the fiber optic cable 20 is from about 7.0 mm to about 11.0 mm, and the height h of the fiber optic cable 20 is preferably from about 3.0 mm to about 6.0 mm. The strength component 26 is located generally adjacent to the optical transmission component 22 and may be in contact with at least a portion of the optical transmission component 22.

Referring now to FIGS. 3-4, another embodiment of a fiber optic cable 20 including at least one optical transmission component and a strength component 26 is shown. The exemplary fiber optic cable 20 comprises at least one buffer tube 22 containing one or more optical fibers 24. The cable shown is a loose tube design. The cable 20 includes a shaped, lengthwise-extending strength component 26 substantially centered within the cable 20. The strength component 26 is axially aligned with the optical transmission component, for example, buffer tube 22, such that the strength component 26 is operable for creating a preferential bend along an axis X-X that is common to both the strength component 26 and the optical transmission component. As shown in FIGS. 3-4, the strength component 26 defines flat side portions 38 and thickened, rod-like ends 40 on opposing sides of the strength component 26.

While the shape of the strength member shown in FIGS. 3-4 increases protection against crush loads and impact forces as compared to the strength member shown in FIGS. 1-2, it does so at the expense of stiffness due to the increase in thickness of the GRP at its ends 40. The effect of the predetermined shape is to provide a limit on how far the fiber optic cable 20 can be crushed before the GRP comes into play. In other words, the predetermined shape having thickened ends coupled with a reduced diameter buffer tube 22 greatly improves its crush and impact resistance. With this design, it is further feasible to add excess fiber length to the buffer tube 22 with or without using bend improved fiber. The objective of this approach is to enable the cable manufacturer to produce a cable with a consistent excess fiber length (EFL) in the 0.1-1.0% range. EFL is a measure of the difference in length between the fiber and the cable. This allows the overall strength requirements for an aerial drop cable to be significantly reduced, while maintaining the same level of fiber reliability under load, due to the lower level of operating fiber strain.

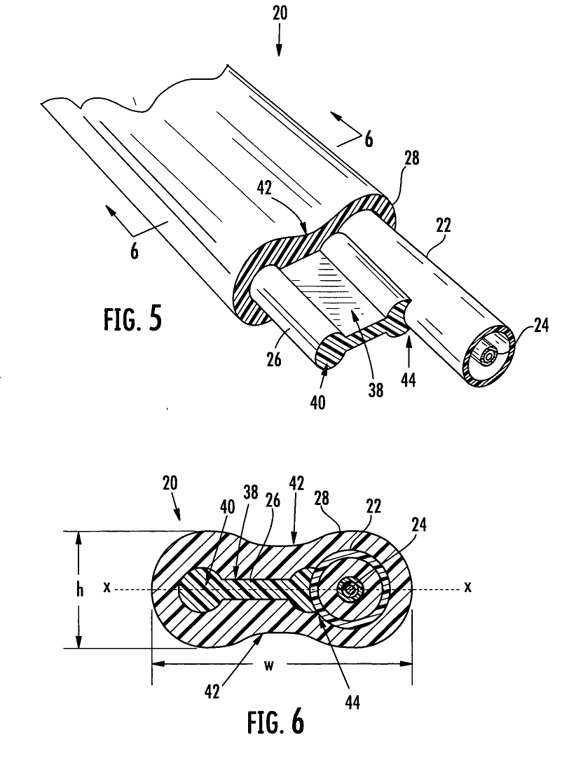

Referring now to FIGS. 5-6, a further exemplary embodiment of a fiber optic cable 20 including a strength component 26 is described and shown in perspective and cross-sectional views. As in the previous embodiments, the fiber optic cable 20 comprises a strength component 26 having a predetermined shape, at least one optical transmission component including at least one optical fiber 24, and a cable sheath 28 surrounding the underlying components. The flexibility of the cable 20 and the preferential bend axis X-X depends primarily on the shape of the strength component 28, the position of the strength and optical components within the cable 20 and with respect to each other, and the material chosen and geometrical configuration of the cable sheath 28.

As shown, the geometrical configuration of the cable sheath 28 defines opposing longitudinal concave surfaces 42 formed during the molding of the cable 20 with a tool having the desired cross-sectional shape. The geometric configuration reduces the amount of material along the top and bottom of the cable 20. The concave shape follows the outer surfaces of the underlying components and reduces the amount of cable sheath material needed. As in the embodiments described above, the minimum average sheath thickness is about 0.75 mm. By the inclusion of the shaped strength component 26 and the geometrical configuration of the cable sheath 28, the cable 20 has a preferential bend along the common axis X-X. In an alternative embodiment, the shape of the strength component 26 may be modified and the geometrical configuration of the cable sheath 28 will still provide a preferential bend along the common axis X-X, although to a lesser extent. Further, the cable sheath 28 may have a flat configuration similar to those shown in the previous embodiments, or may include ribs, raised portions or removed cable sheath portions at predetermined positions around its outer surface while still providing a preferential bend. Flame retardant sheath materials may be selected to achieve plenum, riser, or LSZH flame ratings.

As in the previous embodiments, the fiber optic drop cable 20 is performs well during bending and with attachment hardware, for example, a P-clamp. The GRP side 44 adjacent to the buffer tube 22 may be mated to the buffer tube 22 as shown. The mating has the effect of providing even greater crush support from crush and impact forces. The strength component 26 defines flat side portions 38 and thickened, rod-like ends 40 on opposing sides of the strength component 26. The end 40 adjacent the buffer tube 22 defines a cut away portion complimentary to the shape of the buffer tube 22 portion received. The cable configuration provides good symmetry and rotational stability in the event that the cable is in a loop. Water-swellable yarns may be added at the GRP/buffer tube 22 interface if water tightness is an issue.

In further embodiments, additional strength members (not shown) formed of fiberglass strands may be used to provide additional tensile strength. Preferably, the strength members are multifunctional, including fibrous strength members and a superabsorbent material disposed on and between the strength fibers. The fibrous strength members provide tensile strength, having a tensile strength rating of about 90 Newtons @ 0.5% strain. The superabsorbent material provides water-blocking protection for inhibiting the migration of water in the cable 20. Suitable strength members are made commercially available by Owens Corning. In further aspects of the present invention, a strength member to strength component 26 tensile strength rating ratio is about 0.1 to about 0.5. The combination of the strength component 26 and strength members, with their respective select tensile strength ratings, allows cables of the present invention to withstand high tensile loads and yet have a suitable bending flexibility.

The fiber optic cables of the present invention may be manufactured using any conventional processes known by those skilled in the art. The fiber optic cables may also be manufactured by operation of pressure extrusion tooling (not shown). The extrusion tooling is operative to extrude sheath material 28 about the strength component 26 and the at least one optical transmission component. As the components are fed into the extrusion tooling, a sheathing compound, e.g., polyethylene, is supplied under suitable temperature and pressure conditions to the tooling. The sheathing compound is channeled toward a die and a tip. The sheathing compound then coats the components thereby forming a sheath 28. Pressure extrusion of the melt through an appropriately shaped die orifice results in the formation of a sheath 28 with a predetermined geometrical configuration, such as generally flat-sided or concave. Alternatively, tubing-on plus vacuum drawing the melt during extrusion can form the sheath 28 as well.

Additional water blocking protection may be added to all embodiments. For example, at least one water-swellable tape or yarn (not shown) may be disposed adjacent to the optical transmission component. Preferably, two water-swellable yarns may be counter-helically stranded about buffer tube 22. Cables according to the present invention may include at least one electrical conductor for power or data transmission, for example, at least one coaxial or wire, or a twisted pair of wires. Ripcords and/or an armor layer may be added adjacent buffer tube 22.

The fiber optic cables 20 of the present invention may be employed for operation in the last portion of an optical network in order to provide “fiber-to-the-premises” (FTTP), “fiber-to-the-home” (FTTH) or “fiber-to-the-curb” (FTTC), referred to generically as an FTTx network. The fiber optic cables 20 may be used to bridge the space between the distribution network and the subscriber premises, such as from a mid-span access location of a distribution cable or a “network access point” (NAP) to a subscriber premises. While drop cables may accommodate up to about 12 optical fibers, embodiments including 1, 2 or 4 optical fibers are most common when providing services to a home or business. The various components of the cables 20 may be modified, added or removed in order to meet performance requirements, such as span distance, installation tension, environmental loading conditions, fiber count and cable rated tensile load. The cables 20 of the present invention provide a more simple cable design with fewer components, thus providing potentially less expensive cables having strength equivalent to conventional drop cables.

It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents. For example, the optical transmission component may comprise at least one tight-buffered fiber and/or a bundle of optical fibers. As an alternative to glass reinforced plastic, the strength component may be metallic or aramid fibers impregnated with a suitable plastic material. Additionally, the strength component may take on other shapes while still performing the same function. The concepts described herein may be applied to many cable designs including, but not limited to, self-supporting, buried, indoor, and indoor/outdoor cable applications.

What is claimed is:

1. A fiber optic cable having a preferential bend characteristic, said fiber optic cable comprising:
at least one optical transmission component, the optical transmission component comprising at least one optical fiber therein;
at least one strength component, the at least one strength component being having a predetermined shape and a preferential bend characteristic defining a general preferential bend axis, the strength component positioned generally adjacent the at least one optical transmission component such that the optical component is generally aligned with the preferential bend axis of said strength component; and
a cable sheath surrounding the at least one optical transmission component and the strength component,

2. The fiber optic cable of claim 1, wherein the preferential bend is provided by the strength member, said strength member being axially aligned with the fiber optic cable.

3. The fiber optic cable of claim 1, wherein the strength component has an elongated shape that is generally flat-sided with arcuate ends to provide a preferential bend of the fiber optic cable along the common axis.

4. The fiber optic cable of claim 1, wherein the strength component has an elongated crosss-sectional shape including a generally flat middle portion and thickened ends.

5. The fiber optic cable of claim 4, wherein the thickened ends have a cross-sectional diameter substantially equal to the cross-sectional diameter of the at least one optical transmission component.

6. The fiber optic cable of claim 1, wherein the at least one optical transmission component comprises a buffer tube including at least one optical fiber therein.

7. The fiber optic cable of claim 1, wherein the strength component is generally in contact with the at least one optical transmission component.

8. The fiber optic cable of claim 1, wherein the strength component is formed of a dielectric material.

9. The fiber optic cable of claim 1, wherein the at least one optical transmission component and the strength component have respective centers that are generally aligned along a preferential bend axis.

10. The fiber optic cable of claim 1, further comprising at least one strength member axially aligned with the fiber optic cable.

11. The fiber optic cable of claim 1, further comprising at least one water-swellable yarn helically stranded about the at least one optical transmission component.

12. The fiber optic cable of claim 1, wherein the cable sheath has a predetermined geometric configuration for providing the preferential bend of the fiber optic cable.

13. A fiber optic cable having a preferential bend, comprising:
at least one optical transmission component including at least one optical fiber disposed within the tubular body;
at least one strength component, the strength component having a predetermined elongate shape imparting a preferential bend characteristic to the strength component, said strength component being positioned substantially adjacent the at least one optical transmission component; and
a cable sheath having a predetermined geometric configuration and substantially encapsulating the at least one optical transmission component and the strength component;
wherein the at least one optical transmission component is generally aligned with a preferential bend axis of the strength component.

14. The fiber optic cable of claim 13, wherein the predetermined shape of the strength component is elongate and generally flat.

15. The fiber optic cable of claim 13, wherein the predetermined shape of the strength component is elongate with a generally flat mid portion and thickened ends.

16. The fiber optic cable of claim 15, wherein the thickened ends have a cross-sectional diameter substantially equal to the cross-sectional diameter of the at least one optical transmission component.

17. The fiber optic cable of claim 13, wherein a portion of the strength component is generally in contact with a portion of the at least one optical transmission component.

18. The fiber optic cable of claim 13, further comprising at least one strength member axially aligned with the fiber optic cable.

19. A strength component for a fiber optic cable operable for protecting against crush, impact and torsional forces applied to the fiber optic cable, the strength component comprising a generally elongate shape and is axially aligned with the fiber optic cable.

20. The strength component of claim 19, wherein the strength component is a dielectric material formed into a generally elongated shape having a width greater than a height.

21. claim bending modulus range

22. claim EFL range
